(19) United States
(12) Patent Application Publication
(10) Pub. No.: US 2026/0183647 A1
(43) Pub. Date: Jul. 2, 2026

(54) Systems And Methods For Big, Customized Objects

(71) Applicant: Siemens Aktiengesellschaft, München (DE)

(72) Inventors: Anjelika Votintseva, München (DE); Maryna Zabigailo, München (DE)

(73) Assignee: Siemens Aktiengesellschaft, München (DE)

(21) Appl. No.: 19/131,182

(22) PCT Filed: Nov. 17, 2023
(86) PCT No.: PCT/EP2023/082262

§ 371 Date: May 19, 2025

(30) Foreign Application Priority Data
Nov. 21, 2022 (EP) 22208539.1

(51) Int. Cl. A63F 9/12; B33Y 50/00; B33Y 80/00

(52) U.S. Cl. CPC A63F 9/1208; B33Y 50/00; B33Y 80/00; A63F 2009/1216; A63F 2009/1296

(57) ABSTRACT

The teachings of the present disclosure include systems and methods for creating a big, customized object. An example object includes two or more parts printed on commercially available 3D printers and assembled by a lock and key model of small parts. Each of the two or more parts has a construction template including either scanned and/or calculated pieces.

### CROSS-REFERENCE TO RELATED APPLICATIONS

This application is a U.S. National Stage Application of International Application No. PCT/EP2023/082262 filed Nov. 17, 2023, which designates the United States of America, and claims priority to EP Application No. 22208539.1 filed Nov. 21, 2022, the contents of which are hereby incorporated by reference in their entirety.

### TECHNICAL FIELD

The present disclosure relates to big, customized objects like—for example—an avatar in human size for visualization of an individual to be present in so called “hybrid” meetings combining virtual and physical presence. Various embodiments of the teachings herein include systems and/or methods for producing a big, customized object.

### BACKGROUND

For all kinds of prototyping, it is advantageous to have physical objects on hand. For all kinds of interaction, it is advantageous to have an idea of the personal appearance of the partners. Generative manufacturing like 3D printing allows a quick production of prototypes, however, big, customized objects are difficult to produce due to their volume and weight. During pandemic times participants of meetings became usually virtual meetings and people meanwhile are used to presence, hybrid, and virtual meetings equally. However, during hybrid-meetings, e.g. meetings with virtual attendants and attendants in presence, the attendees in presence do have advantages.

So, it became evident that the socialization in the real world, physical presence is still preferred over virtual presence. The visualization of an individual can be crucial for networking and productive collaboration. During the pandemic times the interaction between users shifted from physical presence to digital world. Nevertheless, people prefer to socialize in the real world. This need inspires conference organizers to propose hybrid meetings, combining virtual and physical presence that became very popular.

As people are used to interacting with audio objects that create a 3D or spatial audio environment that provides the perception of point audio sourced in 3D space, people desire to have for visual interaction an equally overall impression. The technical problem is how to improve the physical representation of an individual in a human-size format from the virtual part of the meeting to mate both worlds and to recreate the presence of a person for the effective mixed communication. The potential solution gives opportunities to caregivers, handicapped, old and other people with travel limits to their presence during the events.

3D printing offers new possibilities for makers, creators, and professionals for personalized production. Nevertheless, the cost for devices as well as material cost is too high, when bigger objects have to be printed. Moreover, during the 3D printing process additional material in a form of support is required to dismiss misprints. All this also implies unnecessary load on the environment with higher printing time and more plastic material utilized.

There are several methods known to 3D print big objects like human bodies for example “makerBot”, “druckzilla”. However, the technical problem is how to print objects this big and/or human size avatars in 3D. There are some big 3D printers known, like “Raise3DPro2Plus Series”, “Stratasys F770”, “bigrep”, “Form 3L-Großformat-SLA-3D-Drucker” von “Formlabs”.

Big printers as state of the art are generally too heavy, too big, and too expensive for uncomplicated and wide-spread use. The printed “state of the art”—results from these printers are not so easy to store and transport, while they represent a solid form. Moreover, the printed results become too expensive if they require numerous supports. As a result, small companies, private businesses, and makers are not able to afford large 3D printers and abandon possible opportunities.

### SUMMARY

Teachings of the present disclosure provide method and systems to produce big, customized objects through a 3D printing method at reduced material consumption. These can provide a big, customized object, obtainable by 3D printing technique with as few support structures as possible that overcomes the disadvantages of the known solutions. For example, some embodiments of the teachings herein include a Big, customized object comprising at least two or more parts obtainable by commonly used 3D printers being assembled by a lock and key model of small parts, having as a construction template either scanned and/or calculated pieces which may be standard and/or individualized.

Some embodiments include a replication of a human and/or being an avatar in human size, having at least arms, legs, middle of the body and a head.

Some embodiments are mounted on a base plate.

In some embodiments, the base plate comprises a technical device able to move on its own—may be moved from distance.

In some embodiments, at least some of the small parts form 3D puzzle parts.

In some embodiments, at least some of the small parts which are constructed as 3D puzzle parts have at least one flat side to be mounted on a 3D printer.

In some embodiments, there are electronic devices such as screens, camera, microphone, and/or speaker incorporated.

In some embodiments, the electronic devices are arranged at the head.

As another example, some embodiments include a method to produce a big, customized object, the method including: Scanning of a body, Scaling a 3D model of the scan, Cutting of the 3D model into pieces, 3D printing of the parts, and Assembling of the parts.

In some embodiments, the method further comprises transforming the pieces into porous structures before printing.

In some embodiments, the method further comprises post-processing treatment of the assembled body in order to optimize its visual appearance.

In some embodiments, the method further comprises incorporating electronic devices into the big, customized object.

In some embodiments, the method involves a calculation and/or printing step of 3D parts by parametric modeling.

In some embodiments, the method involves a calculation and/or printing step of 3D parts using a computer program product that is based on the principle of Voronoi decomposition of a given body.

### BRIEF DESCRIPTION OF THE DRAWINGS

FIG. 1 shows a flowchart for an example method incorporating teachings of the present disclosure;

FIG. 2 shows a pair of big objects fabricating according to teachings of the present disclosure;

FIG. 3 is a schematic drawing showing several puzzle parts of a first layer 11 and a second layer 12 of an assembled object incorporating teachings of the present disclosure;

FIG. 4 is a schematic showing an example connector in form of a lightbulb incorporating teachings of the present disclosure;

FIG. 5 is a schematic that shows an example of a porous structured printed part incorporating teachings of the present disclosure;

FIG. 6 is a schematic showing examples of 3D printed objects realizing Voronoi incorporating teachings of the present disclosure; and

### DETAILED DESCRIPTION

Some embodiments f the teachings herein include a method comprising:
Scanning of a body,
Scaling a 3D model of the scan,
Cutting of the 3D model into pieces,
Optionally transformation of the small pieces into porous structures
3D printing of the—optional porous parts
Assembling of the parts and
Optionally treatment of the assembled body in order to optimize its visual appearance, for example decoration with additional accessories.

Some embodiments include a big, customized object comprising a number of parts being assembled by a lock and key model of small parts obtainable by commonly used 3D printing techniques.

In some embodiments, “cutting the 3D model into pieces” is performed by means of parametric modelling in Grasshopper where cut parameters are defined by systems configuration, like the size of the currently available 3D printers. Grasshopper 3D is a visual programming language and environment that runs within the Rhinoceros 3D computer-aided design application. Grasshopper is a plug-in included in the Rhinoceros 3D modeling software. It is a tool for algorithmic modelling, specifically used for designing and editing complex shapes through certain parameters.

In some embodiments, the 3D scanned body is an individual and/or a big, customized object to be reproduced. 3D-scanning of big objects like human size bodies is state of the art. 3D scanning is the process of analyzing a real-world object or environment to collect data on its shape and possibly its appearance, like its surface roughness, its color, and/or its surface appearance. The collected data can then be used to construct digital 3D models.

A 3D scanner can be based on many different technologies, each with its own limitations, advantages, and costs. Many limitations in the kind of objects that can be digitized are still present. For example, optical technology may encounter many difficulties with dark, shiny, reflective, or transparent objects. For human's 3D models Computer Aided Designs “CAD” techniques may be used.

In some embodiments, the scanning of a big body may be done with a regular scanning device like a mac and/or a regular mobile device like an iphone, for example. Some embodiments include using a phone/camera to take several pictures around the object and stitch them together using photogrammetry to create a 3D scan.

A real-world object and/or a physical environment and/or real environment in contrast to a virtual object refers to a physical object that people can sense and/or interact with as a physical things like bodies, environments like parks, include physical articles, or physical objects or real objects such as physical arms and legs, physical elements, and physical people. People can directly sense and/or interact with the physical environment, such as through sight, touch, hearing taste and/or smell.

After scanning of the body and scaling of the 3D model—or choosing of a given 3D standardized model—, the model is cut into pieces. This transformative feature splits a 3D model into parts for printing in the form of 3D puzzle, for example. Puzzle pieces (virtual) or parts (physically) obey the so-called lock and key model and may be assembled quite simply. In some embodiments, the method includes cutting the 3D model of the scan into pieces for printing in the form of puzzle parts. These calculated or standardized pieces serve as construction template for the 3D printing of the respective parts.

In some embodiments, there is a combination of parts and/or pieces that are calculated after being individually scanned and parts and/or pieces which are standards because of no expected changes by individual scan, like feet, hands, arms, legs, ears . . . Both sorts of parts and/or pieces together build up the final big, customized object. Besides, standard parts and/or pieces may be easily individualized by details being personalized and adjusted to the individual. These pieces or parts may be accordingly standard and individualized.

Even though generally spoken “puzzle” refers to a game which is two dimensional having flat parts being put together to receive a flat image or picture, the parts may be three dimensional and/or product of a 3D-printing process. The parts and/or pieces are not merely 3D-puzzle parts that fit along straight lines one into another, like—for example—interdigital structures. Generally, the parts are often irregularly shaped. Especially the cutting edges of the parts as described herein show—but not necessarily—more complex formed edges, especially in order to not fall apart, e.g. even stick together even under a certain tension. The sticking together is done—for example—by shapes that clip in one another but for release there is a mechanism like a barb holding the parts together.

The parts which are suitable to build up a model are not necessarily simply put together like in a interdigital-structured form that has no barbs, corners, edges and/or curves and so on, but may show a more complicated and complex form of the edge, of course applying to both parts the one that is used as key part and consequently the other being used as lock part, too.

Three-dimensional parts to build up a big customized object may have 3-dimensions with no flat parts. Some are parts with protrusion or cutout on more than one side. The protrusions and cutouts of every two adjacent parts may correspond to each other.

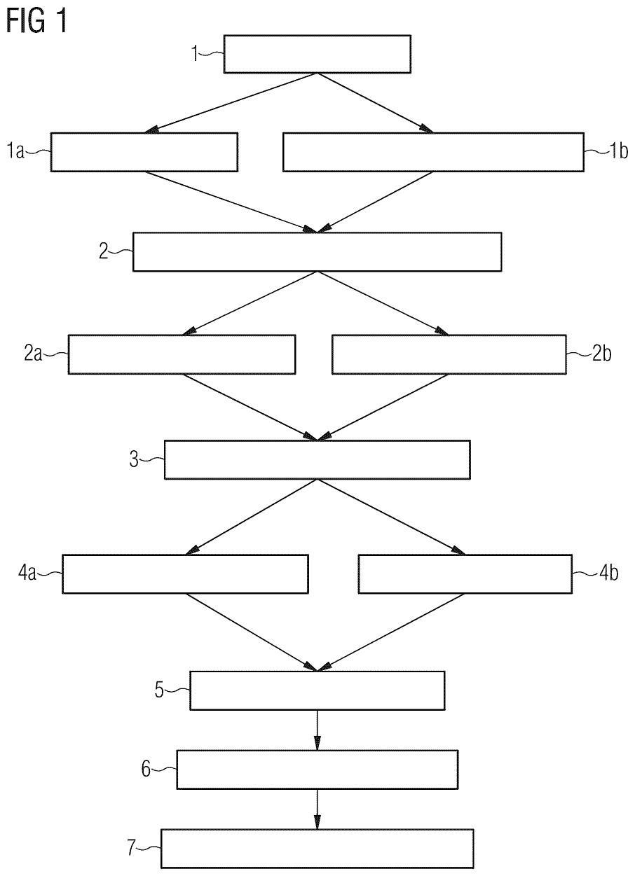

FIG. 1 shows a flowchart for an example method incorporating teachings of the present disclosure. Starting from top to bottom the method may involve the following process:
Step 1: select a 3D model,
Step 1a—alternative a): 3D-scan of an own model,
Step 1b—alternative b): select a standard and customize it,
Step 2: define 3D printing parameters (example: L-B-H or weight),
Step 2a—alternative a): Define own parameter values,
Step 2b—alternative b): Select from standard settings,
Step 3: Calculation of 3D puzzle pieces,
Step 4a—alternative a): individual 3D printing of calculated pieces,
Step 4b—alternative b): Search for available parts from inventory,
Steps 5 and 6: construction of the big, customized object
Step 5: Assemble internal layers,
Step 6: Assemble and adjust external layers, e.g. surface parts,
Step 7: optionally: Integrate electronics into the big, customized object.

The scheme of this method demonstrates the overall process described with more details further in this document. The alternatives on the right side of the scheme (variants b.) refer to a lower cost version of an avatar, whereas the alternatives on the left side a) may provide a more personalized and expensive one.

The selection of the 3D model—process step 1—may be done—see alternative 1a—by scanning of an own model as well as—see alternative 1b—by selecting a standard model that has been provided from the program and/or from earlier scanning of models. These standard models are deposited in a kind of toolbox or memory to be easily available. Such a standard model may be taken as it is or may be customized, e.g. it can be scaled to fit to the customer's height or other size. Such a customized model is based on the chosen standard model and has individualization like-in the case that the model is a human body, the shape of the body, the color of hair, eyes, skin, nails, length of legs, arms, legs, feet, fingers, hands, eyebrows or some other features, like it is common knowledge.

When the model is finished, the process step 2 of defining the 3D parameters is next. Defining the 3D parameters means finding out what size of pieces would be suitable to have them 3D printed by the 3D printer that is available. Accordingly, the user may either define its own parameters—see step 2a—, especially when the 3D model is an individually scanned model and not based on a standard, or the user may select the printing parameters from standard settings—see step 2b.

After defining the 3D printing parameters in length—“L”, width or breadth “B”, height “H”, the calculation of the 3D puzzle pieces is being initiated—see step 3.

The calculation of the puzzle pieces or parts—being the build-up elements of the big, customized object—may be done by different mathematical approaches for the cutting algorithm and languages, one of the possible approaches being Grasshopper in connection with Rhinoceros as mentioned above. See process step 4a as shown in FIG. 1. However, parts of customer specific size will make reuse and component exchange among different avatars more difficult, when they are produced in quite some amount e.g. for conferences and/or fairs where avatars may be used to replace personal presence.

For the alternative, where the user choses a standard model or pieces that form a standard model—see alternative 2b in the process as shown in FIG. 1—there might be basic parts for the build-up of the object or avatar available in a toolbox and do not have to be printed individually—see process step 4b. These parts may be produced as mass products and accordingly cheaper.

Similarly, the calculated virtual pieces may be standard and added to the scan of the model in order to save scanning time and resources of physical models. There might be an individualizing, personalization and/or customization step during calculation and/or programming of the printable piece. This might be done in between the choosing of the standard virtual piece and the final calculation of the virtual individual piece based on a standard form. The individualized version of the standard piece may finally be taken for printing the respective part of the big, customized object.

Standard size and/or form for parts makes it possible to reuse parts in different products and/or avatars to reduce material usage and make production cheaper and more sustainable. The standardized parts help to save costs, material and are thus advantageous for the environment. Besides, it allows cheap and fast exchange and/or reparation. The production of the small parts includes the calculation of their porous structure according to the customer parameters (e.g., wished weight for each part).

Process step 5 covers the assembly of the build-up parts first of internal layers of the avatar or object, process step 6 covers the assembly of the outer and external surface parts and—last but not least—process step 7 of the through FIG. 1 disclosed preferred embodiment of the method of the invention step 7 is the adding, incorporation, and integration of electronics to the avatar. Electronics may be one or more selected from the group of screens, microphone, speaker, camera, engine . . . Devices for interaction with physically present persons may be available and exchangeable.

Generally spoken, once the parts are on hand, respective the printing is done, the avatar can be assembled quickly as a puzzle and re-assembled for storage and/or transportation. The term “avatar” is used for any artificial person, serving as a representative of a person in the physical, real world. In this disclosure, an avatar may be constructed by assembling a number of parts, e.g., assembled by a lock and key mode or, in other words, by 3D puzzle parts. The avatar may have all kinds of supplementary devices, such as microphone(s), speaker(s), screen(s), movable parts like hands, feet, etc. The avatar may be mounted on a movable ground plate with an engine, for example. An avatar that is built up on a base plate with remote control and engine may move on its own and/or may be moved from distance over IoT.

“Big” refers to an object which is not printable by commonly used 3D printers, like an avatar in human h size or any other object exceeding the dimensions of 20×20×20 cm or exceeding 20 cm³. Such objects may not be printed in commonly used 3D printers such as—for example Ultimaker S3and other commonly used 3D fused deposition modeling “FDM”-3D-printers. Those printers are generally limited to installation spaces of about 500×500×500 mm at most. For example, the parts which are used to build up the big, customized object according to one embodiment of present invention may be printed with a 3D printer having an installation space of about 300×250×300 mm, which is already quite large for a commonly used 3D printer.

The parts are 3D printed in such or similar dimensioned installation spaces and accordingly have a rather small volume compared to a person being 180 cm tall and weighing 90 kg. So for the purpose of building an avatar representing a person as described—this avatar being an example for a big customized object as it is subject of the present disclosure—it takes quite a number of parts being printed and assembled. Such an avatar in human size, has at least arms, legs, middle of the body and a head.

Between 2 and 1000, between 5 and 500, or between 10 and 100 of those parts are—for example—put together to become a big, customized object according to one embodiment. “Big” refers to an object of at least a dimension that comprises between 5 and 50 of these parts. It may be—for example—as big as a human body with the volume of a human being 180 cm tall and weighing—as a human not an avatar—100 kg.

The parts being assembled to build up the “big” object or human size avatar are compared to the resulting assembled big, customized object rather “small”. Accordingly does “small” mean being printable by commonly used 3D printers. For example, a printable size object could have the measures of 10×10 or 20×20 cm. “Small” can be bigger, if the printer is quite big. Small parts can be standard parts, like parts of legs, arms, will allow easy preparation, repair, exchange and so on . . .

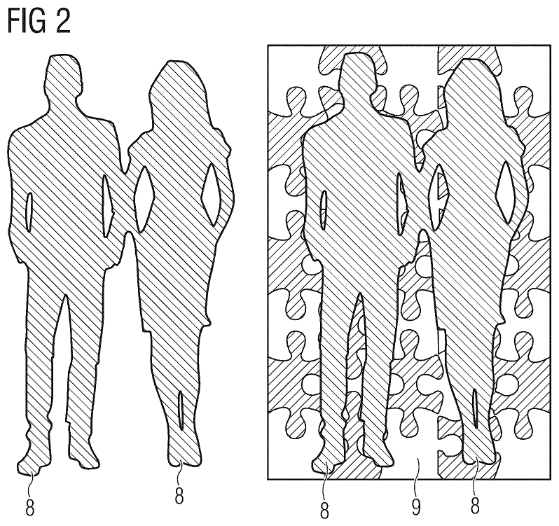

FIG. 2 shows a set of example big objects fabricated according to teachings of the present disclosure, including a human couple 8 showing man and woman as drawn on the left side 8. The objects are represented in front of a puzzle-background 9 to give an example of the size of parts that will be assembled to build up one or two avatar(s) 8, and also an example how the models will be cut (as observed from one perspective) While the inner parts of the avatar—see process step 5 of FIG. 1—may be cubicle other parts of the human bodies will keep the curvatures.

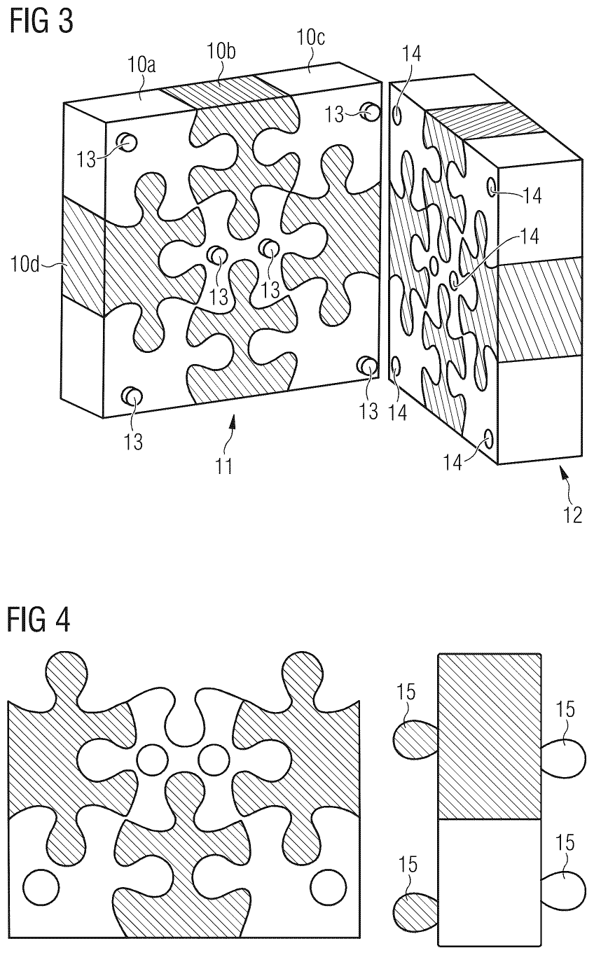

FIG. 3 shows several puzzle parts 10a, 10b, 10c, 10d . . . of a first layer 11 and a second layer 12 of an assembled object—not shown—. The puzzle parts of one layer may be assembled with the puzzle parts of a second layer by knops 13 and holes 14 as shown. The connector between parts may be the fitting of knops 13 and holes 14 as shown in FIG. 3.

In some embodiments, the connector may be in form of a lightbulb 15 as shown in FIG. 4. As shown in FIGS. 3 and 4, the edges of the puzzle parts may be different or equal, having sharp or round corner, as wanted. Further the puzzle parts do not need to comprise the complete surface, it may be enough to have a common frame, while the part itself may be hollow.

In some embodiments, the printed puzzle part lacks supporting structures during the print process. In some embodiments, a cutting algorithm calculates the slopes and guarantees that they are all kept below 45°. For example, the puzzle parts have a spheric shape or 45-degree angles to dismiss supports in the printing process. Typically, slopes less than or equal to 45 degrees can be printed without supports.

In some embodiments, the parts are constructed so that each part has at least one flat surface without curvature on this surface. This surface will be the bottom of the part during 3D printing. All connecting knops and holes are on the sides of the piece perpendicular to the bottom surface or on the top of the piece (see FIGS. 3 & 4). To connect different layers with each other, pieces within each layer are connected alternating the direction of their flat side. For example, all white pieces will have their flat sides in front and all other pieces-on the back side of the layer.

The parts or pieces of a big, customized object may be equal or different. This technique offers additional opportunities for cost reduction due to overall printing material minimization and reduction of the post-processing time. In some embodiments, the variation and quality of the printed parts that may vary in different ways.

To save material and weight, it may be advantageous to print the parts with low density. This means that printed parts of a porous structure built up at least as stable an avatar as heavy full dense parts. However, low density parts are easier to transport and assemble and save material and print costs.

The term “pieces” is used for the calculated pieces of the 3D model, being virtual, while the term “parts” is used for the printed physical parts.

FIG. 5 shows an example of a porous structured printed part 15 incorporating teachings of the present disclosure. Such a part may also be calculated and generated by parametric modeling with Grasshopper as mentioned above. Such a porous structured part reduces some important parameters like printing weight, printing material, costs and printing time.

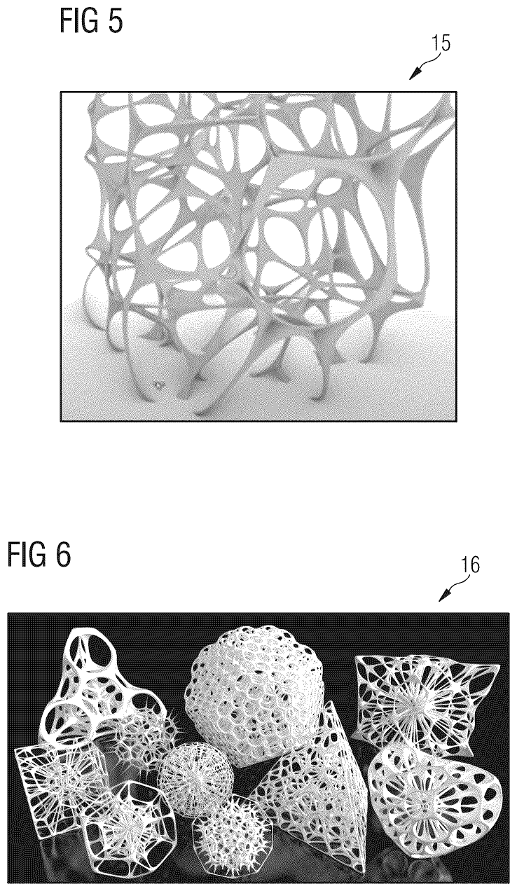

Another possibility is to use Voronoi texture or Voronoi structure for the surface only and exclude the filament inside of the avatar. This is shown in FIG. 6, where examples of 3D printed objects 16, realizing Voronoi structures are shown. This can be achieved by Rhino/Grasshopper with Voronator, Voronoi plug in, Fusion 360 with the 3D Voronoi add-in, Dynamo, nTopology, and Blender with scripting. These are computer program products using the principle of Voronoi decomposition of a given body. This principle divides the body into cells which are also known as Voronoi cells and Thiessen polygons. Besides, it is possible to have different densities realized within one printed part. This applies for more sophisticated forms.

In case Voronoi structure is applied to the sophisticated forms, the Voronoi curve attractor line approach can be used to perform calculation. The winding areas stay solid, but the rest is transformed to porous structure. There are 2 possibilities to arrange the appearance of the outermost pieces:

The outermost surface of the avatar may be printed solid with a thin layer. Only the internal structure will be porous.

In some embodiments, the whole avatar, all pieces, will be printed porous as shown on FIG. 6. In this case, the avatar can be customized further filled in with foam, cloth or threads of different colors, still keeping weight very low. Different colors will imitate personal cloth style, hair style, other design solutions.

The parametric cutting algorithm can also calculate the form of the avatar's head with a place for a LCD display on the front side. The display will be connected to a microcontroller with the internet capability (connected to the conference's WiFi). This display will show the face of the owning participants, who wants to participate remotely from a different location and still interact with other participants in a natural physical way (not only in the virtual meeting rooms). Just above or below the display there will be a webcam mounted, which will transfer the environment to the remote participant owning this avatar.

Currently there is no technology on the market, which offers a puzzle transformation for additive manufacturing. The teachings herein allow the printing of large parts. The methods and systems not only prepare personalized avatars for better user experience, but can be applied for any other large item, which makes it convenient. This technology offers stability due to the puzzle form and can be used for more sophisticated 3D models.

Currently available 2D Photo Avatars do not provide authentic view for the participants. They are not customizable and not reusable. Their production requires large printers and large wood/cardboard plates. They cannot hide electronics due to their 2D flat nature.

The body parts can be reused for the new avatars, which makes this solutions sustainable and multifunctional. To achieve this, it may be necessary to create two models: one model for a head (one puzzle) and another for the body (another puzzle).

The advantages of puzzle technique may include:
Opportunity to print big objects with a usual printer, so the process is sustainable
Quick assembling of a printed object like a puzzle and reusage of standard parts—like arms, feet, fingers etc . . . —for many realizations→convenient & sustainable
Reduced material cost due to porous structure→less material cost and a shorter printing time (less energy consumption)
Reassembling due to modular structure→better storage
Absence of support with 45-degree angles approach→material cost reduction and post-processing time reduction

Due to its modular nature, all the parts can be reassembled and reused that makes this approach sustainable.

Independent of the grammatical term usage, individuals with male, female or other gender identities are included within the term.

From a very cheap and silent avatar which cannot leaving a corner during the meeting to a very lively avatar, looking around, answering questions, and moving around everything may be realized with the techniques described herein. This makes such avatars even more customizable for different levels. Such avatars can be used not only for hybrid conferences, but also in all kinds of interactive communication with clients, family etc. In this sense a thus constructed avatar may serve as a kind of customized baby-phone—in form and size of a mother/grandmother/etc.—or as caregivers in different facilities for elderly people or disabled patients as well as for peds care.

What is claimed is:

1. A big, customized object comprising:
two or more parts printed on commercially available 3D printers and assembled by a lock and key model of small parts;
wherein each of the two or more parts has a construction template including either scanned and/or calculated pieces.

2. A big, customized object according to claim 1, the objecting including an avatar in human size with at least one arm, one leg, a torso, and a head.

3. A big, customized object according to claim 2, mounted on a base plate.

4. A big, customized object according to claim 3, wherein the base plate comprises a motor operable to move the avatar.

5. A big, customized object according to claim 1, wherein at least some of the small parts form 3D puzzle parts.

6. A big, customized object according to claim 5, wherein at least some of the 3D puzzle parts have a flat side to be mounted on a 3D printer.

7. A big, customized object according to claim 1, further comprising an incorporated electronic device.

8. A big, customized object according to claim 7, wherein the electronic device is arranged at the head.

9. A method to produce a big, customized object, the method comprising:
scanning a body;
scaling a 3D model of the scanned body;
cutting the 3D model into pieces which can be printed on commercially available 3D printers;
3D printing at least one piece of the 3D model to form part of the object; and
assembling the part with at least one additional part to form the object.

10. A method according to claim 9, further comprising transforming the pieces into porous structures before printing the at least one piece.

11. A method according to claim 9, further comprising post-processing treatment of the assembled body to optimize a visual appearance.

12. A method according to claim 9, further comprising incorporating electronic devices into the big, customized object.

13. A method according to claim 9, wherein the calculation and/or printing step of 3D parts includes parametric modeling.

14. A method according to claim 9, wherein the calculation and/or printing step of 3D parts includes Voronoi decomposition of a given body.
